(19) United States
(12) Patent Application Publication
(10) Pub. No.: US 2009/0135288 A1
(43) Pub. Date: May 28, 2009

(54) Optical scanning module with linear CMOS image

(76) Inventors: San-Woei Shyu, Taipei (TW); Kon-Son Wang, Taipei (TW); Ching-Yuan Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/984,998

(22) Filed: Nov. 26, 2007

(51) Int. Cl. H04N 5/225

(52) U.S. Cl. 348/340; 348/E05.024

(57) ABSTRACT

An optical scanning module with linear CMOS image sensor (linear CMOSM) applied to scanners or multi-function printers is disclosed. The optical scanning module includes a light source for emitting light, a reflection mirror group, a focus lens group, and a linear CMOS image sensor having at least one linear CMOS image sensor unit and one A/D analog-digital converter. The light source can be a cold cathode fluorescent lamp (CCFL), a Xenon lamp or linear LED. Light emitted from the light source projects onto an object being scanned. Then the light reflected by the object being scanned becomes scanning light, passing through the reflection mirror group and the focus lens group and being focused on the linear CMOS image sensor for being converted into electrical signal. By A/D conversion of the linear CMOS image sensor unit in the linear CMOS image sensor, signal is sent out in USB or LVDS format so as to achieve high scanning speed, low distortion, large depth of focus and convenient transmission.

### BACKGROUND OF THE INVENTION

The present invention relates to an optical scanning module of imaging systems, especially to an optical scanning module with linear CMOS image sensors that is applied to imaging systems such as scanners or multi-function printers.

The imaging systems available now such as scanners, printers, fax machines or multi-function printers (MPF) convert optical signal obtained by light scanning objects into electrical signal for various applications. Most of the imaging systems include art optical scanning module. The operation of the optical scanning module is performed by a light source therein emitting light onto figures or words being scanned. The light reflected from the figures or words is received and is converted into corresponding electrical signal by an image sensor. The images sensor of the optical scanning module is divided into two categories: CCD (Charge Coupled Device) and CIS (Contact Image Sensor). Due to long-term development and mature technology, CCD has lower signal-to-noise ratio (S/N) ratio and thus CCD offers superior image scanning quality than CIS. However, CIS has features of low cost, compact volume and fast start-up so that it's suitable for small dimensions. The short startup time is caused by no adjustment and no warm-up.

Refer to FIG. 1, a conventional CCD (Charge Coupled Device) optical scanning module (CCDM) 1 is known. For optimum effect, a light source 11 is a cold cathode fluorescent lamp (CCFL) that emits white light, passing through a narrow aperture (not showing in FIG. 1), lighting on scanning target 10. Then the reflected light passes through a reflecting lens 12 and a focusing lens 13 to be focused to form an image on a CCD 16. According to user's requirements, CCD 16 can be an image sensor with high-, middle- or low-resolution. The length of the CCD 16 is much shorter than the width of an object being scanned 10 such as documents or figures so that the image needs to be diminished by the reflecting lens 12 and the focusing lens 13 for completely scanning. When light is reflected by a A4 size object 10 through the reflecting lens 12 and the focusing lens 13 to the CCD 16, calculated that the focal length of focusing lens 12 is need about 1 meter. Although the module with larger DOF (depth of focus) can be used to scan paper with wrinkles or curls, volume of the CCDM 1 is also increased. Because the CCD 16 gets smaller volume in comparison with the scanning target 10 and the light emitted to the scanned object 10 needs to be focused to the CCD 16, the necessity of adjustment is increased while assembling the device. Moreover, the CCD 16 may have a quite low signal-to-noise ratio (S/N) and a good-quality colorful image can be scanned as prior arts disclosed in JP2006-067504 and US2004/263915.

There are two kinds of CCD 16, array CCD and linear CCD. The main drawback of the CCDM 1 formed by the CCD 16 is in that it requires additional electric elements for converting analog signal to digital signal that is sent for applications. This is called back-end function of image capture. The elements required are as shown in FIG. 3. For example, low voltage differential signaling (LVDS) is a standardized data transmission format. Once the data is transmitted in this format, an analog-to-digital (A/D) converter/transmitter 15 includes a timer 14, an emitter 153, an A/D converting unit 151 and a LVDS transmission unit 152. By control of the timer 14, electronic generated from the CCD 16 is sent by the emitter 153 in the form of analog signal and the A/D converting unit 151 converts the analog signal into digital signal. Then the LVDS transmission unit 152 transmits the digital signal in LVDS format. Because the CCD 16 is unable to be integrated with these back-end elements into one element, the structure is more complicated, the reliability is reduced and the cost is raised. Therefore, development of the CCDM is restricted to some extent.

Refer to FIG. 2, a CIS (Contact Image Sensor) optical scanning module 2 includes a light source 21. Most of the light source 21 is a linear light source formed by light-emitting diodes (LED). The linear LED light source 21 is produced by arranging LED chips on a strip of printed circuit board at equal distance from each other. Light emitted from the LED chips is refracted by a light guide (not shown in this figure) to form uniform light source that is distributed and emitted into a scanned object 20. After reflected by the scanned object 20, the light passes a rod lens 22 to form an image on a CIS 23. The CIS 23 turns the scanning light into electrical signal. Through a timer 24 and an analog-to-digital (A/D) converter/transmitter 25, the electrical signal is sent out in digital way for applications. Refer to FIG. 4, take an Array CSIM as an example. Once the A/D converter/transmitter 25 sends signal out in low voltage differential signaling (LVDS) format, elements required for back-end function of image capture includes, timer 24, horizontal decoding unit 232, vertical decoding unit 233, A/D converting unit 251 and LVDS transmission unit 253. Where the timer 24 generating timing signal for driving a horizontal decoding unit 232 to convert horizontal signal of the CIS 23 through an A/D converting unit 251 and a LVDS transmission unit 253. The horizontal signal is converted into LVDS format and is sent out. On the next timing signal, timing signal generated from the timer 24 drives a vertical decoding unit 233 to convert vertical signal of through the A/D converting unit 251 and the LVDS transmission unit 253 for converting the vertical signal into LVDS format and transmitting the vertical signal out. Please refer to prior arts revealed in US2005/0145701, U.S. Pat. No. 7,166,827, US2003/0076552, US2007/0035785 U.S. Pat. No. 6,827,269.

Because the rod lens 22 is formed by a line of small diameter radial gradient index lens in which refraction index changes along radial direction so that the rod lens 22 with imaging function can form an image. By means of the rod lens 22, an image of figure or words of the object being scanned 20 is formed on the CIS 23 in ratio of 1:1. That means that the length of the CIS 23 is the same as the length of the object being scanned 20. The advantage of the rod lens 22 is short light path while the shortcoming of the rod lens 22 is short depth of focus. Due to short depth of focus, the object being scanned 20 should be more smooth and lying flat, and attach on a certain surface of the scanner. When there are wrinkles or curls area on surface of the object, wrinkle area is going to form black image. Thus CIS is more difficult to develop into lens for scanning 3-dimensional objects. Refer to lens for CCDM or CSIM disclosed in CN200620175613, or image scanning devices with longer depth of focus revealed by U.S. Pat. No. 6,111,244, both make scanning light form an image on the CIS 23 by combination of lens and reflection mirrors to get good depth of focus.

On the other hand, the CIS 23 can be produced by standard CMOS (Complementary Metal-Oxide-Semiconductor) logic processes. Thus Array CMOS (area CMOS) and linear CMOS are produced. Generally, Array CMOS is usually applied to compact camera modules for image capturing. Refer to US2007/0024926, US2007/0045510 and TW00490977, all reveal the Array CMOS applied to image capture devices. As to U.S. Pat. No. 7,113,215, US2005/0145701 and US2003/0146994, all disclose related technology of the CMOS applied to image sensors. However, an additional analog to digital converter and transmitter is still need for signal transmission. Refer to US2002/0096623, a linear CMOS is revealed while US2002/0096625 discloses data transmission of the linear CMOS. Therefore, the linear CMOS is used for image sensing.

The linear COMS has only a line of optical sensors so that the speed of the linear COMS is faster than the speed of the array CMOS. Moreover, the linear CMOS has less power consumption so that power load of portable electronic products is featured. Therefore, there is a need to develop a kind of optical scanning module with low power consumption, high speed, and convenience in signal transmission.

Moreover, for meeting requirements of multi-function printers (MPF) such as convenient and fast transmission for other applications after scanning and providing more integrated transmission interface such as a SOC (system on chip) having a linear CMOS integrated with back-end elements-ADC (A/D converter), DSP (digital signal processor), encoder, and interface, there is a need to develop a transmission way for linear CMOS with convenience, easiness, and high reliability.

### SUMMARY OF THE INVENTION

For scanning data transmission, the conventional linear CCDM has drawbacks of low reliability and high cost. As to CISM with CMOS, it has problems of smaller depth of focus, lower S/N ratio, and requirements of additional A/D converter as well as other transmission devices. Therefore it is a primary object of the present invention to provide an optical scanning module with linear CMOS image sensor (linear CMOSM) that consists of a light source for emitting light, a reflection mirror group, a focus lens group, and a linear CMOS, image sensor having at least one CMOS image sensor unit. The light source can be cold cathode fluorescent lamps (CCFL), Xenon lamps or linear LED. Light emitted from the light source projects onto the object being scanned. Then the light reflected by the object being scanned becomes scanning light, passing through the reflection mirror group and the focus lens group and being focused on the linear CMOS image sensor for being converted into electrical signal. By A/D conversion of the linear CMOS image sensor unit in the linear CMOS image sensor, signal is sent out in USB or LVDS format. Therefore, requirements of high scanning speed, low distortion, large depth of focus and convenient transmission maybe achieved.

### BRIEF DESCRIPTION OF THE DRAWINGS

FIG. 1 is a schematic drawing showing structure of a CCDM according to a prior art;

FIG. 2 is a schematic drawing showing structure of a CISM according to a prior art;

FIG. 3 is a block diagram of a CCDM according to a prior art;

FIG. 4 is a block diagram of a CISM according to a prior art;

FIG. 5 is an explosive view of an embodiment according to the present invention;

FIG. 6 is a block diagram of an embodiment with LVDS transmission according to the present invention;

FIG. 7 is a block diagram of an embodiment with USB transmission according to the present invention;

FIG. 8 is a block diagram of an embodiment with AD transmission according to the present invention;

FIG. 9 shows timing of an embodiment with AD transmission according to the present invention;

FIG. 10 is an explosive view of another embodiment according to the present invention.

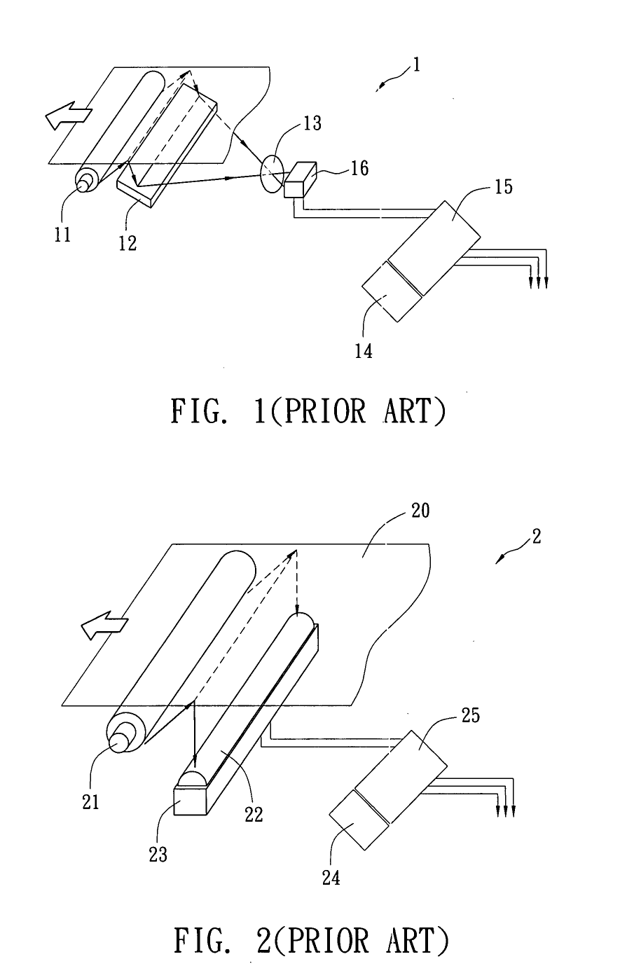

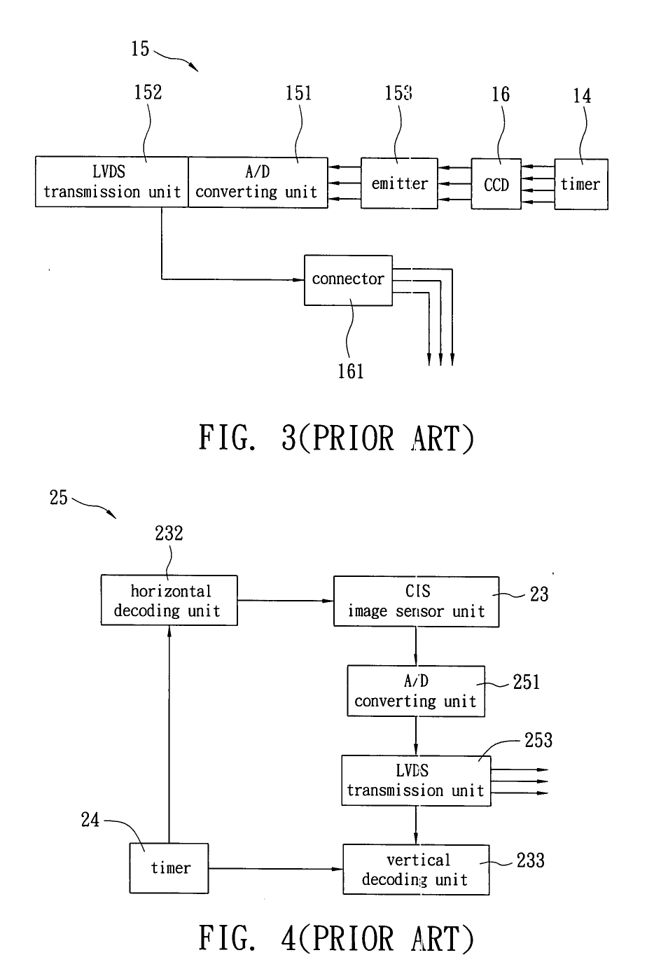

### DETAILED DESCRIPTION OF THE PREFERRED EMBODIMENT

### First Embodiment

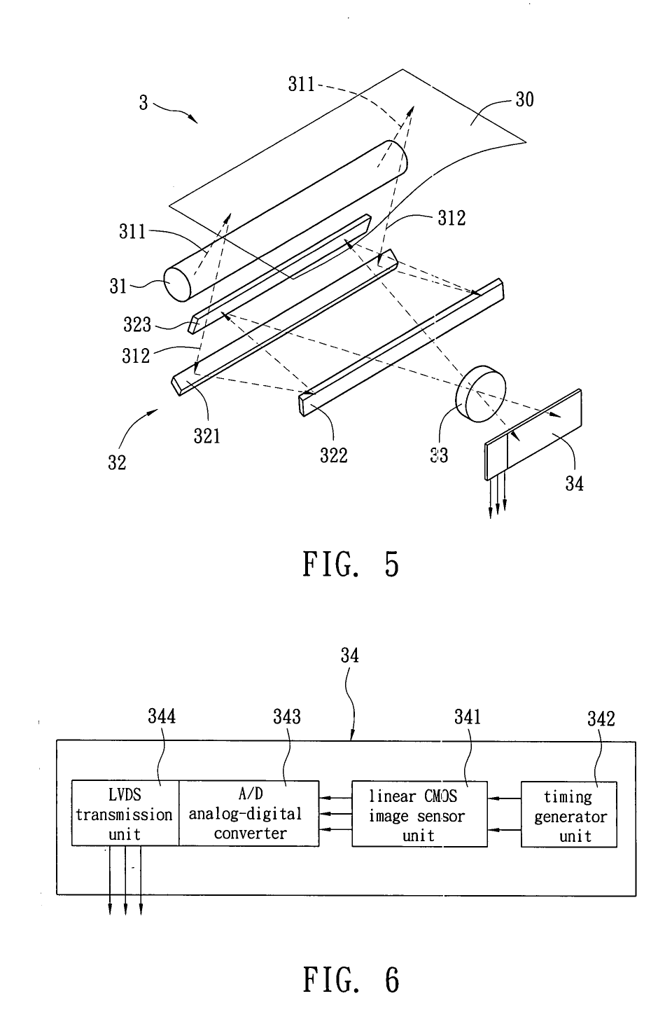

Refer to FIG. 5, an optical scanning module with linear CMOS image sensor (linear CMOSM) 3 is applied to a scanner. An object being scanned 30 is a A4-size document, being set on glass plate of the scanner. The linear CMOSM 3 according to the present invention disposed inside the scanner includes a light source 31 formed by a cold cathode fluorescent lamp (CCFL) for emitting light 311 onto the object being scanned 30 and the light 311 reflected by the object being scanned 30 is scanning light 312. A reflection mirror group 32 consists of at least one reflection mirror. In this embodiment, the reflection mirror group 32 is composed by a first focus lens 321, a second focus lens 322, and a third focus lens 323. The scanning light 312 firstly emits onto the first focus lens 331 and then is reflected by the first focus lens 321, the second focus lens 322, and the third focus lens 323 in sequence. By arrangement of the reflection mirror group 32, the predetermined light path is formed in a certain (limited) space. Thus volume of the linear CMOSM 3 is reduced. Moreover, after reflected by the reflection mirror group 32, the scanning light 312 reflects to the focus lens group 33, where that the lens group 33 is grouping by at least one focus lens or a plurality of focus lens to form different focal ratios. In this embodiment, the focus lens group 33 consists of three pieces of focus lens (two glass lens and one plastic lens). With 600 dpi resolution, focal ratio of the reflection mirror group 32 to the scanning light 312 is 8× to 10×. By means of the focus lens group 33, length of the scanning light is shortened, further aberration is corrected and an image is formed on a linear CMOS image sensor 34. Thus length of the image formed is shorter than width of the A4-size document and the resolution is not sacrificed. The linear CMOS image sensor 34 converts the scanning light 312 into electrical signal after forming of the image.

Refer to FIG. 6, a linear CMOS image sensor 34 includes a linear CMOS image sensor unit 341, a timing generator unit 342, an A/D analog-digital converter 343 and a LVDS transmission unit 344. The timing generator unit 342 is to generate timing signal for control of the linear CMOS image sensor unit 341 to perform sampling. In other embodiment, the timing generator unit 342 may be replaced by timing signal being input from externals. That means the sampling of the linear CMOS image sensor unit 341 is controlled by external timing being input. The A/D analog-digital converter 343 converts sampled electrical signal into digital signal while the LVDS transmission unit 344 turns the digital signal into LVDS format and sends the digital signal out. The linear CMOS image sensor 34 is a SOC (System On a Chip) that is formed by integration of the linear CMOS image sensor unit 341, the timing generator unit 342, the A/D analog-digital converter 343 and the LVDS transmission unit 344 into a semiconductor chip so as to achieve low manufacturing cost, compact volume, high productivity, high reliability, high resolution, and low optical-distortion.

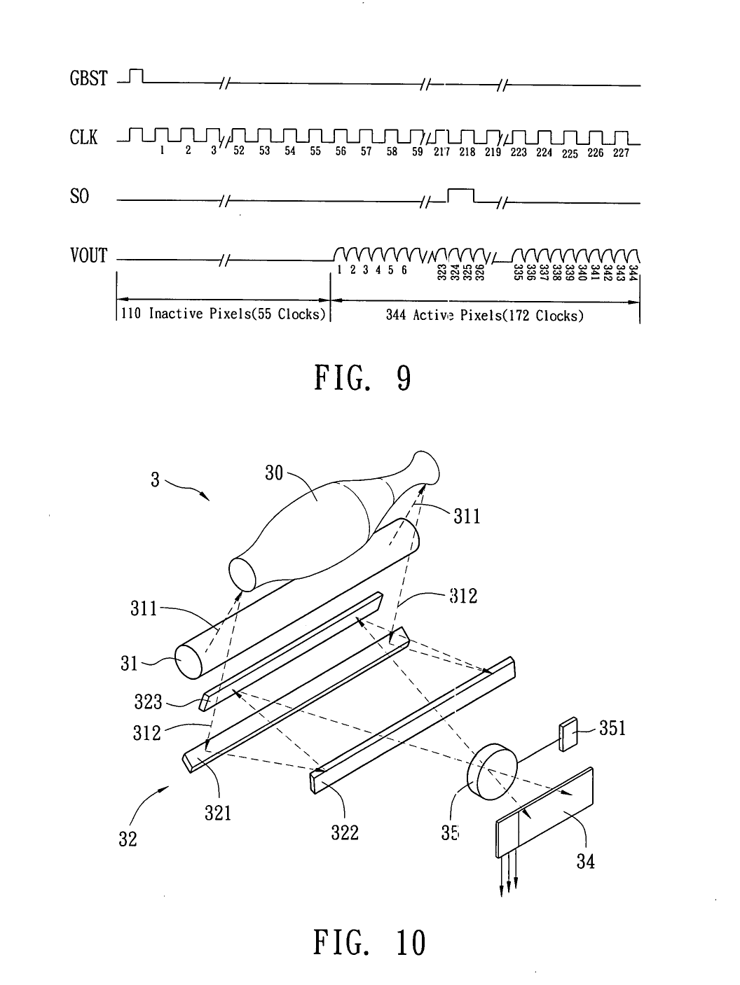

Refer to FIG. 9, CLK is timing signal generated by the timing generator unit 342, GBST is Global start pulse, SO is end of scan pulse, while VOUT is analog signal of video output voltage. In this embodiment, a product PI6050D manufactured by AMI Semiconductor that is a linear CMOS image sensor unit with 600 dpi resolution is used. For example, when the timing generator unit 342 generates timing signal or timing signal input by external devices, until the 55th timing signal, equivalent to 110 inactive pixels, the image sensing starts up capturing the image. Until to the 172th timing signal, equivalent to 344 active pixels are performed by the imaging sensing between the time interval.

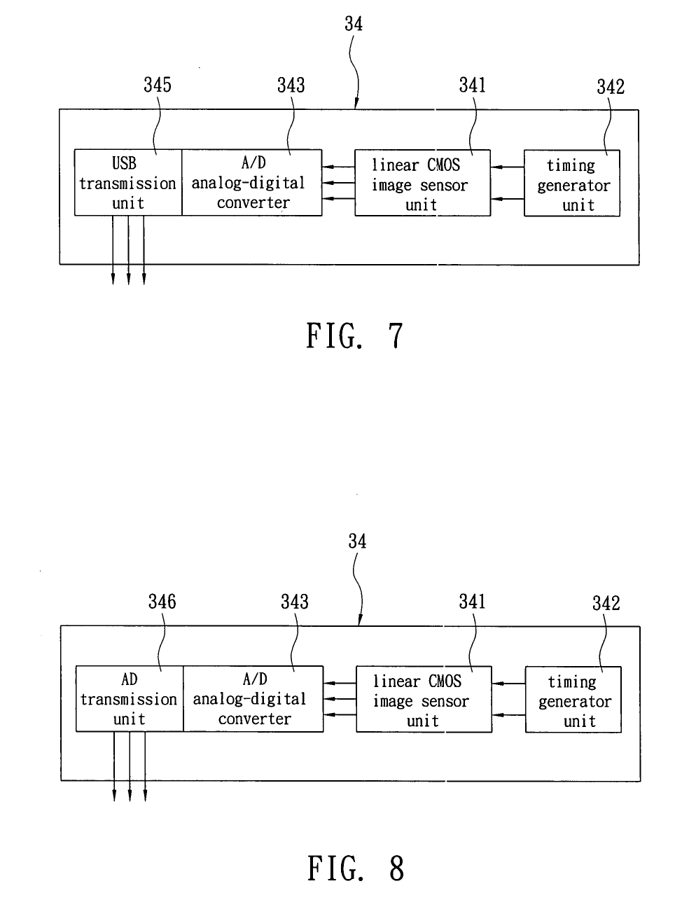

Refer to FIG. 7, another embodiment is disclosed. The LVDS transmission unit 344 is replaced with a USB transmission unit 345 that converts the digital signal into USB format and sends the signal out. Or as shown in FIG. 8, the LVDS transmission unit 344 is replaced with an A/D transmission unit 346 that converts the digital signal into A/D format and sends the signal out.

In this embodiment, the focus lens group 33 with a focal ratio of 8 consists of three lenses. A first lens, a second lens and a third lens are respectively the aspherical glass lens, the spherical glass lens and the spherical plastic lens. Thus width of original scanning light can be reduced by means of the reflection mirror group 32 and the focus lens group 33 so that the linear CMOS image sensor unit 341 with smaller size can be used. In this embodiment, the object being scanned is a A4 size document with width of 297 mm. As to conventional CISM, length of the CIS image sensor is no less than 297 mm. However, in this embodiment, length of the linear CMOS image sensor unit 341 can be reduced to less than 60 mm. By means of a plurality of reflection mirrors of the reflection mirror group 32, light path is effectively shortened. Therefore, volume of the optical scanning module according to the present invention is effectively minimized.

When the object being scanned 30 is a reflective object, scanning light 312 is reflected along the mirrors of reflection mirror group 32, there is an optical difference between the right side and the left side thereof. Once the focus lens group 33 is formed by lens with short back focal length ratio, the optical aberration is corrected and is near to the object being scanned. Thus scanning resolution is improved.

In this embodiment, the linear CMOS image sensor unit 341 is manufactured by using logic CMOS process or DRAM process and is composed of a plurality of photodiode. Each photodiode converts light to electrical current. The photodiode (photo-sensor) with associated control gates form a pixel (picture element). The more photodiode in a unit area, the higher the pixel is. Because the photodiode generates electrical signal in response to incident light, light intensity or strength directly has effect on electrical signals and further influencing pixel quality. When aberration of the scanning light 312 incident into the linear CMOS image sensor unit 341 is smaller, deviation of the electrical signal in response is also smaller. Thus pixel resolution is higher. By the focus lens group 33 together with the linear CMOS image sensor 34, the scanning light 312 is focused to form an image on the linear CMOS image sensor 34 while the resolution will not be sacrificed due to image reduction, aberration and distortion. Thus shortcomings of conventional CIS sensor such as smaller depth of focus and lower resolution are improved.

Furthermore, the linear CMOS image sensor 34 is a SOC (System On a Chip) that is formed by integration of linear CMOS image sensor unit 341, timing generator unit 342, A/D analog-digital converter 343 and LVDS transmission unit 344 into a semiconductor chip so as to increase reliability and reduce cost. In addition, the scanned electrical signal is transmitted into other devices in digital formats such as LVDS, USB or A/D format easily and conveniently. This is another effect of the present invention.

### Second Embodiment

Refer to FIG. 10, in another embodiment of the linear CMOSM 3 according to the present invention, the focus lens group 33 is replaced by an A/F (autofocus) zooming lens 35 and an A/F controller 351. By the A/F controller 351, focal point of the A/F zooming lens 35 is adjusted automatically so as to enhance convenience of use of the linear CMOSM 3. Furthermore, distortion caused by rough surface of the object being scanned (a 3-dimensional object in FIG. 10, for example) is prevented. The A/F zooming lens 35 includes at least two sets of lens while at least one set of lens is removable and the movement of the lens set is controlled by the A/F Controller 351. By changes of distances between the lens sets resulted from auto adjustment movement, the scanning light 312 is automatically focused to from an image on the linear CMOS image sensor unit 341. Thus three-dimensional object can be scanned.

When documents with ruffling surfaces or three-dimensional objects are scanned, light 311 emits onto surface, reasoning in variation of distances there between, the reflection positions are also different. Thus position of the image formed on the linear CMOS image sensor unit 341 also changes. By control of the A/F Controller 351, the A/F zooming lens 35 affects focal point of the scanning light 312 from different scanning positions so as to make a clear image form on the linear CMOS image sensor unit 341.

### Third Embodiment

When the cold cathode fluorescent lamp (CCFL) is used as the light source 31 of the present invention, the light source 31 consists of a cold cathode fluorescent lamp and a narrow aperture. Length of the light source 31 is set as scanning width of the object being scanned. The cold cathode fluorescent lamp has phosphors coated on an inner surface thereof, mercury and a rare gas enclosed therein. By applying high voltage between two electrodes of the CCFL, electrons shot from the electrode are speeded up by high voltage and then collide with mercury atom. After colliding, there is an overflow of the energy that occurs from the mercury atom returns rapidly from unstable state to stable state radiates by ultraviolet (253.7 nm). The radiated ultraviolet is absorbed by fluorescent powder and is transformed to visible light. By passing the narrow aperture, the light becomes a strip of light whose width is the same with the scanning width of the object being scanned. The light projected onto the scanned object is reflected to form scanning light, focused by the reflection mirror group 32 and the focus lens group 33 and converted into electrical signals by the linear CMOS image sensor 34.

When the Xenon lamp is used as the light source 31 of the present invention, the light source 31 is composed of a Xenon lamp and a narrow aperture. Length of the light source 31 is the same with the scanning width, of the object being scanned. The Xenon lamp is filled with gas mixture He:Xe:NF₃ in the ratio of 100:2:1. There is 500 pulses output per second and the average power of the lamp is 500w with higher efficiency. The narrow aperture makes light emitted from the Xenon lamp become strip-like light that projects onto the scanned object.

When the light source 31 is LED, it can be a linear LED that includes one of several LED chips arranged on a strip of printed circuit board at equal distance from each other. When light emits from the linear LED, it projects onto the object being scanned directly or in a certain direction.

Compared with conventional CCDM or CISM, a linear CMOSM 3 of the present invention formed by the linear CMOS image sensor 34 and optical elements has following advantages:

<1> Compared with conventional CISM, the linear CMOSM 3 according to the present invention has features of reduced cost, compact volume, high resolution, low optical distortion, high productivity and high scanning reliability.
<2> Compared with conventional CISM, the linear CMOSM 3 according to the present invention has better transmission of electrical signals. Moreover, there is less restriction on light sources of linear CMOSM 3. In accordance with users requirements, various light sources can be used.
<3> In a conventional CISM having a rod lens, the scanning light is reflected by the scanned object, then passing through the rod lens to form an image on the CIS image sensor (as shown in FIG. 2) so that the conventional CISM has no DOF (depth of focus) effect while the linear CMOSM 3 according to the present invention achieves DOF effect.
<4> In conventional CSIM, a light guide plate is required when linear LED is used as light source so that light emits from the LED is refracted by the light guide plate to form light source with uniform luminance. Thus light emits homogeneously onto the object being scanned. However, the use of the light guide plate reduces effect of the LED light source. That means luminance of light passed through the light guide plate is decreased and this leads to negative effect on scanning speed. If users want to accelerate scanning speed, luminance (power) of the LED light source needs to be increased. At the same time, this also generates more heat and leads to trouble on applications of conventional CSIM. But the linear CMOSM 3 of the present invention makes full use of light by optical design of the reflection mirror group and the focus lens group to form an image on the linear CMOS image sensor 34. Therefore, conventional light guide plate of CISM can be eliminated. The present invention not only increases light efficiency of the light source, but also improves scanning speed.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An optical scanning module with a linear CMOS image sensor comprising
a light source for emitting light onto the object being scanned to being scanning light;
a reflection mirror group that reflects the scanning light along predetermined optical path;
a focus lens group that focuses the scanning light from the reflection mirror group to form an image; and
a linear CMOS image sensor that converts the image into digital electrical signal and transmits the digital electrical signal in digital formats;
wherein the reflection mirror group comprising at least one reflection lens for reflection the scanning light along the predetermined optical path;
wherein the focus lens group comprising at least one optical lens that focuses the scanning light and correcting aberration of the scanning light;
wherein the linear CMOS image sensor comprising a linear CMOS image sensor unit, a timing generator unit, an A/D analog-digital converter and a transmission unit, integrated into a system on chip (SOC);
wherein the said linear CMOS image sensor unit converts the image into electrical signal;
wherein the timing generator unit is to generate timing signal for control of the linear CMOS image sensor unit;
wherein the A/D analog-digital converter converts electrical signal from the linear CMOS image sensor unit into digital signal;
wherein the transmission unit converts the digital signal from the A/D analog-digital converter into preset transmission formats for being transmitted.

2. The optical scanning module as claimed in claim 1, wherein said light source is a cold cathode fluorescent lamp that emits light in a certain direction onto the object being scanned.

3. The optical scanning module as claimed in claim 1, wherein said light source is a Xenon lamp that emits light in a certain direction onto the object being scanned.

4. The optical scanning module as claimed in claim 1, wherein said light source is linear LED having at least one LED and the linear LED emits light in a certain direction onto the object being scanned.

5. The optical scanning module as claimed in claim 1, wherein said digital format of the linear CMOS image sensor for signal transmission is AD format, LVDS format, USB format or combinations of them.

6. The optical scanning module as claimed in claim 1, wherein said focus lens group further comprising an A/F (autofocus).zooming lens and an A/F controller; focus of the AF zooming lens is controlled by the AF controller so that scanning lights from different positions are adjusted into the same focal point and an image is formed on the linear CMOS image sensor unit.

7. An optical scanning module with a linear CMOS image sensor comprising
a light source for emitting light onto the object being scanned to being scanning light;
a reflection mirror group that reflects the scanning light along predetermined optical path;
a focus lens group that focuses the scanning light from the reflection mirror group to form an image; and
a linear CMOS image sensor that converts the image into digital electrical signal and transmits the digital electrical signal in digital formats;
wherein the reflection mirror group comprising at least one reflection lens for reflection the scanning light along the predetermined optical path;
wherein the focus lens group comprising at least one optical lens that focuses the scanning light and correcting aberration of the scanning light;
wherein the linear CMOS image sensor comprising a linear CMOS image sensor unit, an A/D analog-digital converter and a transmission unit, all integrated into a system on chip (SOC);
wherein the linear CMOS image sensor unit receives timing signal being input from externals and converts the image into electrical signal according to the timing signal;
wherein the A/D analog-digital converter converts electrical signal from the linear CMOS image sensor unit into digital signal;
wherein the transmission unit converts the digital signal from the A/D analog-digital converter into preset transmission formats for being transmitted.

8. The optical scanning module as claimed in claim 2, wherein said light source is a cold cathode fluorescent lamp that emits light in a certain direction onto the object being scanned.

9. The optical scanning module as claimed in claim 2, wherein said light source is a Xenon lamp that emits light in a certain direction onto the object being scanned.

10. The optical scanning module as claimed in claim 2, wherein said light source is linear LED having at least one LED and the linear LED emits light in a certain direction onto the object being scanned.

11. The optical scanning module as claimed in claim 2, wherein said digital format of the linear CMOS image sensor for signal transmission is AD format, LVDS format, USB format or combinations of them.

12. The optical scanning module as claimed in claim 2, wherein said focus lens group further comprising an A/F (autofocus) zooming lens and an A/F controller; focus of the A/F zooming lens is controlled by the A/F controller so that scanning lights from different positions are adjusted into the same focal point and an image is formed on the linear CMOS image sensor unit.
